(19) United States
(12) Patent Application Publication
(10) Pub. No.: US 2018/0327231 A1
(43) Pub. Date: Nov. 15, 2018

(54) MOTORIZED TRANSPORT SYSTEM

(71) Applicant: SHAGBARK LLC, Chappaqua, NY (US)

(72) Inventor: Robert GUKEISEN, Chappaqua, NY (US)

(21) Appl. No.: 15/755,542

(22) PCT Filed: Apr. 28, 2017
(86) PCT No.: PCT/US17/30001

§ 371 Date: Feb. 26, 2018

(51) Int. Cl. B66B 21/10; H01B 7/02; H02G 3/08; H01B 1/02

(52) U.S. Cl. CPC B66B 21/10; H01B 1/02; H02G 3/081; H01B 7/02

(57) ABSTRACT

Disclosed is a motorized transport system comprising: a transport line comprising: a first cable; a second cable, wherein the first and second cable are made of a second conductor; and, an insulation layer, wherein the insulation layer is made of an insulator; wherein the insulation layer bonds the first cable to the second cable, insulates the first cable from the second cable, and, does not allow the first cable to contact the second cable; a plurality of line anchors fastened to the transport line; a power means for supplying an electric current to the first and second cable; and, a chassis comprising: a housing; a first motor; at least one first cable pulley; at least one second cable pulley; a junction box; a first internal power supply link; a first cable pulley-junction box link; a junction box-second cable pulley link.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a novel motorized transport system. The motorized transport system utilizes a novel approach to draw electricity from a pair of uninsulated cables to supply electricity to internal and external devices. Sometimes attempting to transport cargo and people may be difficult due to environmental, geographical, logistical, economical, and other reasons. The present invention solves these problems. For example, the present invention can be utilized to transport people when road conditions may be dangerous because the present invention does not require the use of highways that may be icy. Furthermore, the present invention may be installed and utilized where there are no roads.

### BRIEF SUMMARY OF THE INVENTION

An object of the present invention is a motorized transport system comprising: a transport line, wherein the transport line comprises: a first cable, wherein the first cable is made of a first conductor; a second cable, wherein the second cable is made of a second conductor; and, an insulation layer, wherein the insulation layer is made of an insulator; wherein the insulation layer bonds the first cable to the second cable; wherein the insulation layer insulates the first cable from the second cable; and, wherein the insulation layer does not allow the first cable to contact the second cable; a plurality of line anchors, wherein the transport line is fastened to the plurality of line anchors; a power means for supplying an electric current to the first cable and the second cable; and, a chassis, wherein the chassis comprises: a housing; a first motor; at least one first cable pulley; at least one second cable pulley; a junction box; a first internal power supply link; a first cable pulley-junction box link; a junction box-second cable pulley link; wherein the chassis being adapted to be movable along the transport line; wherein the first cable pulley-junction box link connects the at least one first cable pulley to the junction box; wherein the junction box-second cable pulley link connects the junction box to the at least one second cable pulley; wherein the power means, the first cable, the at least one first cable pulley, the first cable pulley-junction box link, the junction box, the junction box-second cable pulley link, the at least one second cable pulley, and the second cable form a closed circuit; wherein the first internal power supply link provides electrical power from the junction box to the first motor; and, wherein the first motor drives the at least one first cable pulley.

Another object of the present invention is a motorized transport system, wherein the insulator is selected from a group consisting of epoxy, glass, rubber, fiberglass, porcelain, ceramic, quartz, plastic, diamond and combinations thereof.

Yet another object of the present invention is a motorized transport system, wherein the insulator is epoxy.

Another object of the present invention is a motorized transport system, wherein the first conductor is selected from a group consisting of silver, copper, gold, aluminum, zinc, nickel, tin, brass, bronze, steel, iron, platinum, lead, and combinations thereof; and, wherein the second conductor is selected from a group consisting of silver, copper, gold, aluminum, zinc, nickel, tin, brass, bronze, steel, iron, platinum, lead, and combinations thereof.

Yet another object of the present invention is a motorized transport system, wherein the first conductor is copper; and, wherein the second conductor is copper.

Another object of the present invention is a motorized transport system, wherein the chassis further comprises: a second motor; and, a second internal power supply link, wherein the second motor drives the at least one second cable pulley.

Yet another object of the present invention is a motorized transport system, wherein the motorized transport system further comprises: a load connector, wherein the load connector extends from the chassis.

Another object of the present invention is a motorized transport system, wherein the motorized transport system further comprises: a load container, wherein the load connector couples the load container to the chassis.

Yet another object of the present invention is a motorized transport system, wherein the chassis further comprises a plurality of external power supply links; and, wherein the plurality of external power supply links provides electrical power from the junction box to the load container.

Another object of the present invention is a motorized transport system, wherein the load container comprises: an HVAC system, wherein the HVAC system receives electrical power from the plurality of external power supply links.

Yet another object of the present invention is a motorized transport system, wherein the load container comprises: an illumination system, wherein the illumination system receives electrical power from the plurality of external power supply links.

Another object of the present invention is a motorized transport system, wherein the load container comprises: a wireless fidelity system, wherein the wireless fidelity system receives electrical power from the plurality of external power supply links.

Yet another object of the present invention is a motorized transport system, wherein the motorized transport system further comprises: a motor controller system.

Another object of the present invention is a motorized transport system, wherein the motor controller system is located within the load container; and, the motor controller system receives electrical power from the plurality of external power supply links; and, wherein the motor controller system operates the first motor and the second motor.

Yet another object of the present invention is a motorized transport system, wherein the junction box comprises: a transformer; an inverter; and, a rectifier.

Another object of the present invention is a motorized transport system, wherein the load container comprises: a load container motor, wherein the load container motor receives electrical power from the plurality of external power supply links.

Yet another object of the present invention is a motorized transport system comprising: a transport line, wherein the transport line comprises: a first cable, wherein the first cable is made of a first conductor; a second cable, wherein the second cable is made of a second conductor; and, an insulation layer, wherein the insulation layer is made of an insulator; wherein the insulation layer bonds the first cable to the second cable; wherein the insulation layer insulates the first cable from the second cable; and, wherein the insulation layer does not allow the first cable to contact the second cable; a plurality of line anchors, wherein the transport line is fastened to the plurality of line anchors; a power means for supplying an electric current to the first cable and the second cable; a chassis, wherein the chassis comprises: a housing; plurality of external power supply links; at least one first cable pulley; at least one second cable pulley; a junction box; a first cable pulley-junction box link; and, a junction box-second cable pulley link; a load connector, wherein the load connector extends from the chassis; and, a load container, wherein the load connector couples the load container to the chassis; wherein the plurality of external power supply links provides electrical power from the junction box to the load container; wherein the chassis being adapted to be movable along the transport line; wherein the first cable pulley-junction box link connects the at least one first cable pulley to the junction box; wherein the junction box-second cable pulley link connects the junction box to the at least one second cable pulley; and, wherein the power means, the first cable, the at least one first cable pulley, the first cable pulley-junction box link, the junction box, the junction box-second cable pulley link, the at least one second cable pulley, and the second cable form a closed circuit.

Another object of the present invention a motorized transport system, wherein the chassis further comprises: a first motor; and, a first internal power supply link; wherein the first internal power supply link provides electrical power from the junction box to the first motor; and, wherein the first motor drives the at least one first cable pulley.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a perspective view of an embodiment of the transport line and power means of the present invention.

FIG. 2 is a cross sectional view of an embodiment of the transport line of the present invention.

FIG. 3 is a perspective view of an embodiment of the transport line and line anchor of the present invention.

FIG. 4 is a perspective view of an embodiment of the transport line, line anchor and chassis of the present invention.

FIG. 5 is a top perspective view of an embodiment of the transport line and line anchor of the present invention.

FIG. 6 is a top perspective view of an embodiment of the transport line and line anchor of the present invention.

FIG. 7 is a perspective view of an embodiment of the transport line, line anchor and chassis of the present invention.

FIG. 8 is a perspective view of an embodiment of the transport line, chassis, load connector and load container of the present invention.

FIG. 9 is a perspective view of an embodiment of the transport line, chassis, load connector and load container of the present invention.

FIG. 10 is a top perspective view of an embodiment of the transport line of the present invention.

FIG. 11 is a cross sectional view of an embodiment of the transport line of the present invention.

FIG. 12 is a perspective view of an embodiment of the transport line, line anchor and power means of the present invention.

FIG. 13 is a top perspective view of an embodiment of the transport line of the present invention.

FIG. 14 is a cross sectional view of an embodiment of the transport line of the present invention.

FIG. 15 is a perspective view of an embodiment of the transport line, line anchor and power means of the present invention.

FIG. 16 is a perspective view of an embodiment of the transport line, line anchor, chassis, load connector and load container of the present invention.

FIG. 17 is a perspective view of an embodiment of the transport line, line anchor and chassis of the present invention.

FIG. 18 is a perspective view of an embodiment of the transport line, line anchor, and power means of the present invention.

FIG. 19 is a perspective view of an embodiment of the transport line, line anchor and chassis of the present invention.

FIG. 20 is a perspective view of an embodiment of the motorized transport system of the present invention.

FIG. 21a to FIG. 21d are perspective views of an embodiment of the transport line, chassis, load connector and load container of the present invention.

FIG. 22 is a perspective view of an embodiment of the transport line, line anchor, and chassis of the present invention.

FIG. 23 is a perspective view of an embodiment of the transport line, chassis, load connector and load container of the present invention.

### DETAILED DESCRIPTION OF THE INVENTION

The present invention is a motorized transport system 1000 comprising a transport line 100, a plurality of line anchors 200, a power means 300, and a chassis 400. The motorized transport system 1000 may optionally comprise a load connector 500. The motorized transport system 1000 may further optionally comprise a load container 600.

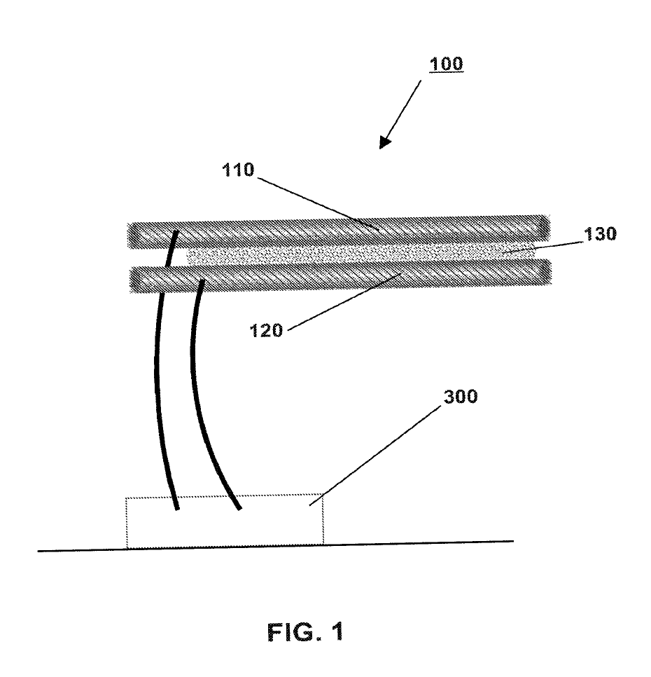

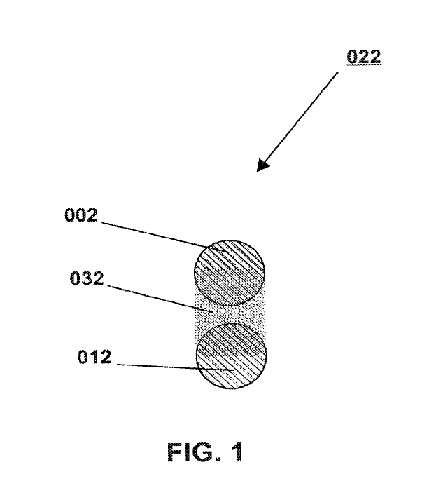

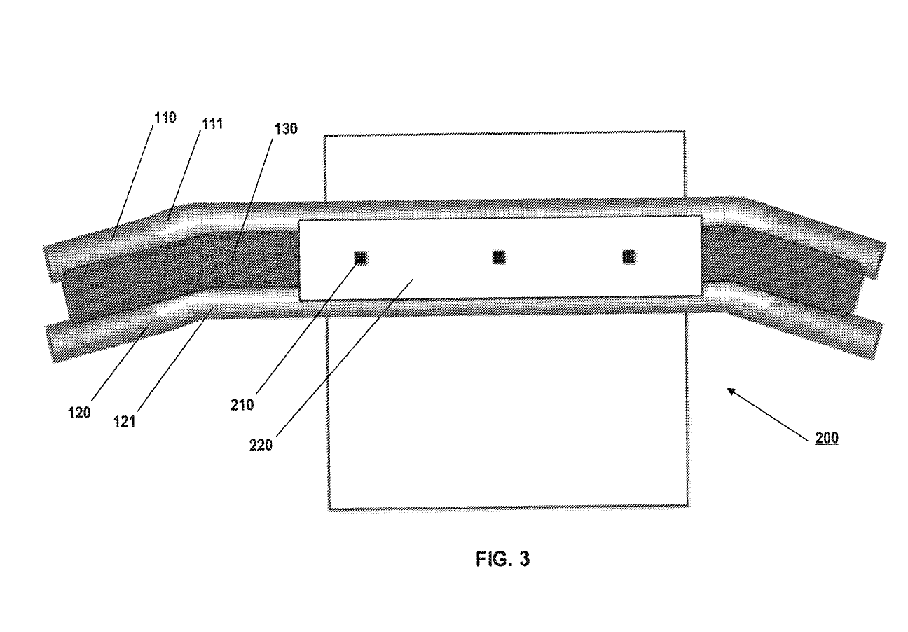

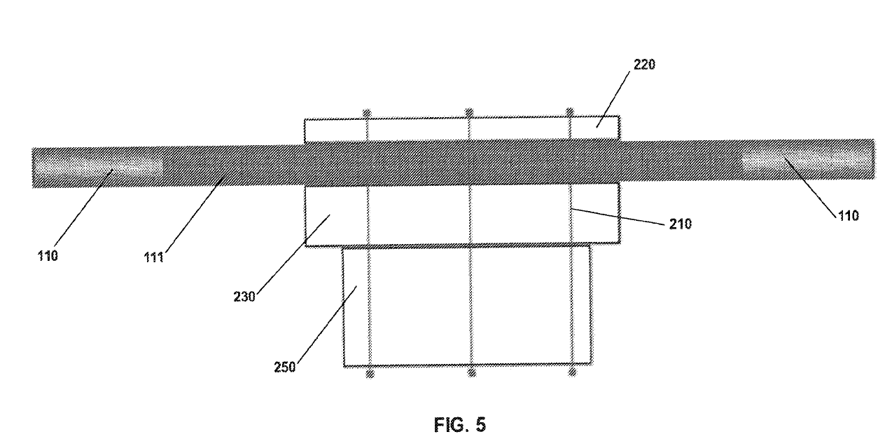

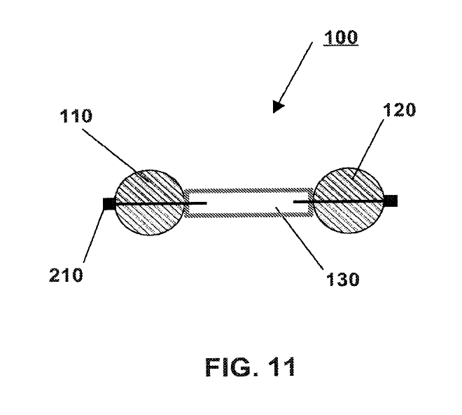

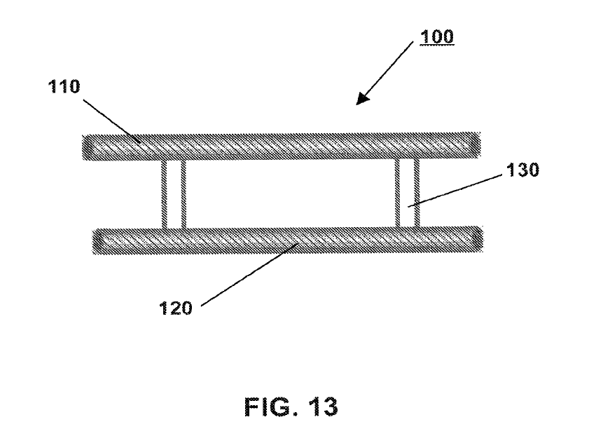

As illustrated in FIGS. 1-4, 7-19 and 23, the transport line 100 comprises a first cable 110, a second cable 120 and an insulation layer 130. The first cable 110 and second cable 120 are made of a first conductor and a second conductor, respectively. Preferably, the first cable 110 and second cable 120 are steel braided wire where the diameter of the cables will be of a suitable size to carry weight for a particular application. The first cable 110 and second cable 120 may be constructed of flexible and rigid sections. For example, as illustrated in FIGS. 3 and 5, first cable 110 may optionally contain a solid and rigid first steel bar 111. The rigidity of the steel bar 111 may make the attachment of the first cable 110 to the line anchor 200 more secure. Similarly, the second cable 120 may also optionally contain a solid and rigid second steel bar 121 that functions as the first steel bar 111. As FIG. 3 illustrates, the first steel bar 111 and second steel bar 121 are curved in the vertical or y-axis plane. An alternative embodiment may be where the first steel bar 111 and second steel bar 121 are curved in the horizontal or x-axis plane. This embodiment facilitates the transportation of cargo in nonlinear directions. Another embodiment may be where the first steel bar 111 and second steel bar 121 are curved in both the horizontal/x-axis and vertical/y-axis planes.

The first conductor and second conductor are selected from a group consisting of silver, copper, gold, aluminum, zinc, nickel, tin, brass, bronze, steel, iron, platinum, lead, and combinations thereof. Preferably, the first conductor and second conductor are copper.

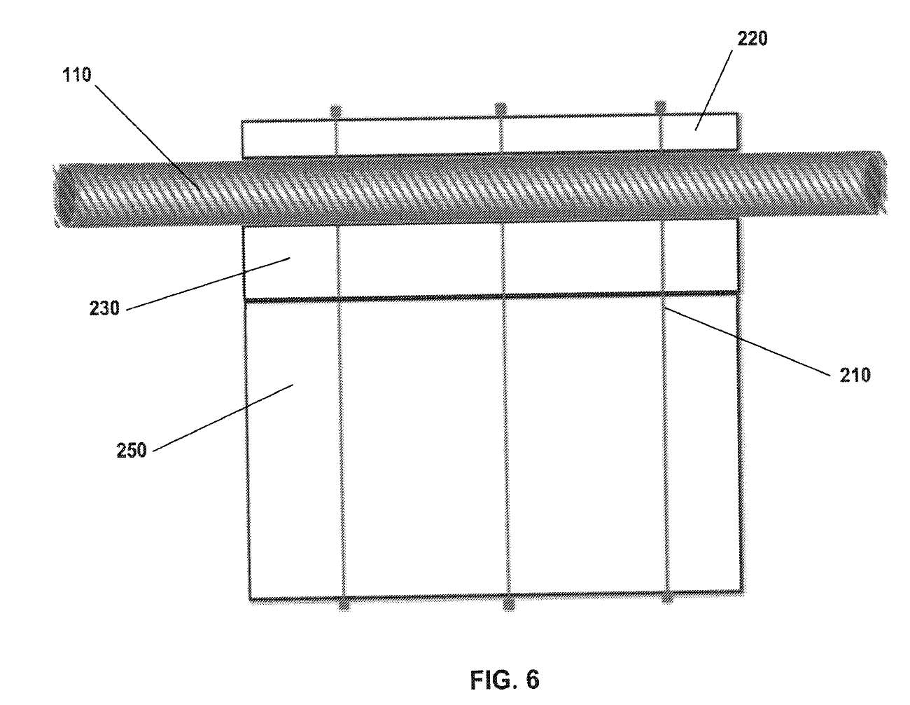

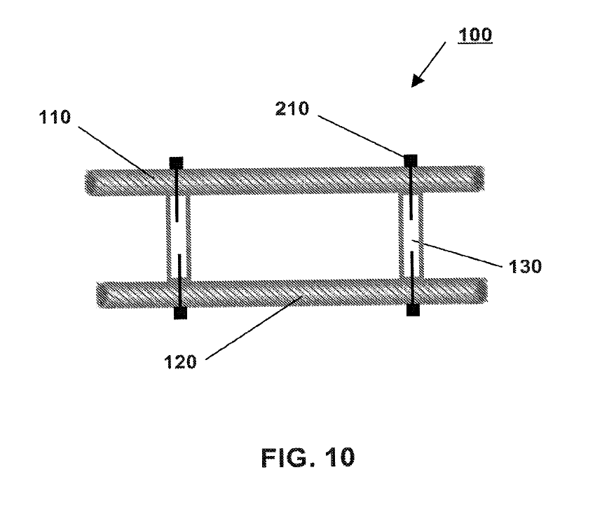

The transport line 100 may be manufactured in various configurations and designs. For example, in FIGS. 1-9 and 23, the transport line 100 is configured in a vertical fashion where the first cable 110 is on top of the second cable 120, with the insulation layer 130 between the first cable 110 and the second cable 120. Alternative embodiments of the transport line 100 are shown in FIGS. 10-19, where the transport line 100 is configured in a horizontal fashion where the first cable 110 is to the left of the second cable 120, with the insulation layer 130 between the first cable 110 and the second cable 120. These are illustrative examples and one of ordinary skill in the art understands that the transport line 100 is not limited vertical and horizontal embodiments.

The first cable 110, the insulation layer 130 and the second cable 120 may be integrally formed into the transport line 100. For example, during manufacturing, the first cable 110 may be adhered to the insulation layer 130 and the second cable 120 may also be adhered to the insulation layer 130. Alternatively, the first cable 110, the second cable 120 and the insulation layer 130 may be manufactured separately, then later assembled as a transport line 100 by utilizing bolts 210, as illustrated in FIGS. 10-12. Furthermore, the transport line 100 may be integrally formed and bolts 210 may be utilized to add to the stability of the transport line 100.

The insulation layer 130 is made of an insulator. Also, the insulation layer 130 bonds the first cable 110 to the second cable 120. Furthermore, the insulation layer 130 insulates the first cable 110 from the second cable 120. Additionally, the insulation layer 130 does not allow the first cable 110 to contact the second cable 120.

The insulator is selected from a group consisting of epoxy, glass, rubber, fiberglass, porcelain, ceramic, quartz, plastic, diamond and combinations thereof. Preferably, the insulator is epoxy.

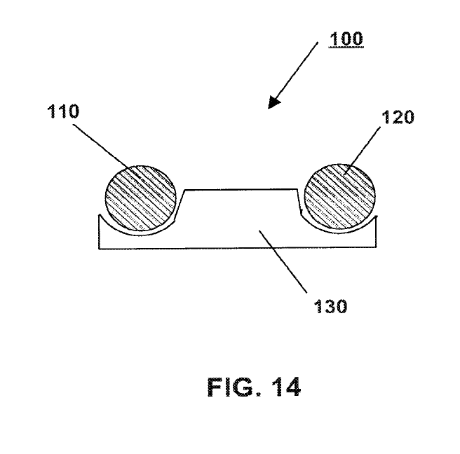

The insulation layer 130 is not limited to being only in between the first cable 110 and the second cable 120. As illustrated in FIGS. 14, 15 and 18, the insulation layer 130 is in between and below the first cable 110 and second cable 120. The insulation layer 130 may provide additional support to the first cable 110 and second cable 120. One of ordinary skill in the art understands that the figures are illustrative and not limiting, as the insulation layer 130 may be of any configuration as long as the insulation layer 130 does not impede the movement of the chassis 400 along the transport line 100.

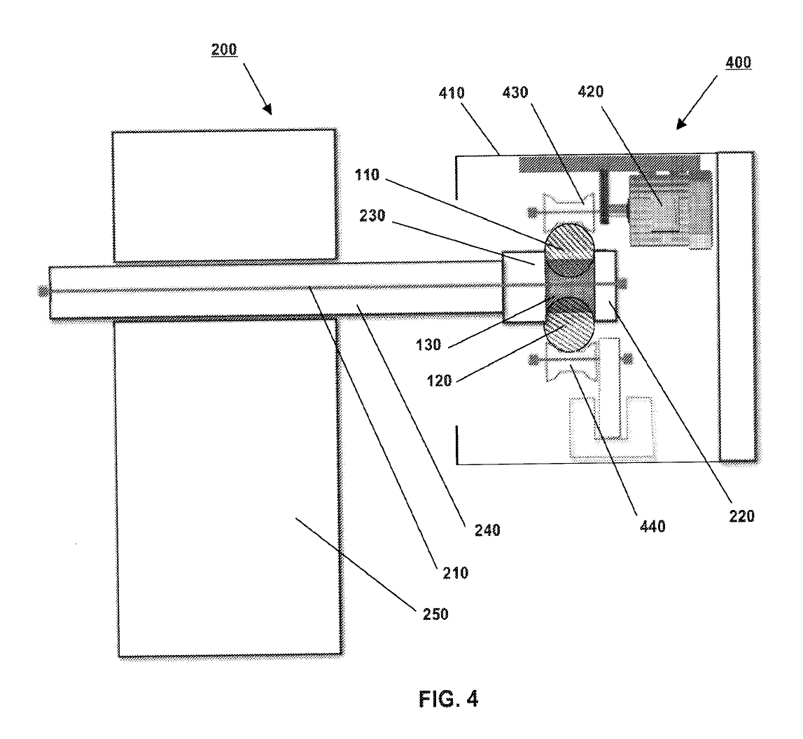

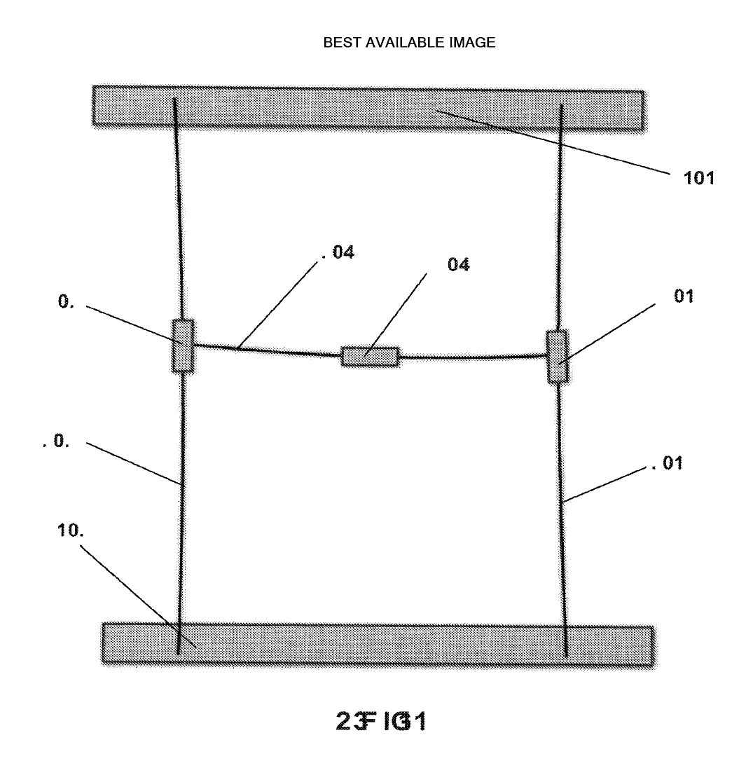

As illustrated in FIGS. 3-7, 12, 15-20 and 22, the transport line 100 is fastened to the plurality of line anchors 200. The line anchors 200 may be a pole, such as a standard utility pole, as shown in FIGS. 4, 7, 12, 15, and 18-20. The line anchor may be any suitable substrate where the transport line 100 may be securely attached. For instance, as shown in FIG. 22, third transport line 103 is securely attached to first chassis 401 at one end and to second chassis 402 at the other end. Also, illustrated in FIG. 22, first line anchor 201 and second line anchor 202 are the walls of a building. In this embodiment, one end of first transport line 101 is securely attached to first line anchor 201 and to the second line anchor 202 at the other end. Similarly, one end of second transport line 102 is securely attached to first line anchor 201 and to the second line anchor 202 at the other end.

FIGS. 3-6 illustrate a method of fastening the transport line 100 to the line anchor 200 with bolts 210. In the example, the line anchor is a pole 250. A support arm 240 is connected to the pole 250. The assembly also includes non-conductive internal cap 230 and non-conductive end cap 220. Bolts 220 are driven through the end cap 220, then through the insulation layer 130, then through the internal cap 230, and then through the support arm 240. Bolts 220 may be made up of any material, including steel, because the bolts 220 do not contact either the first cable 110 or second cable 120.

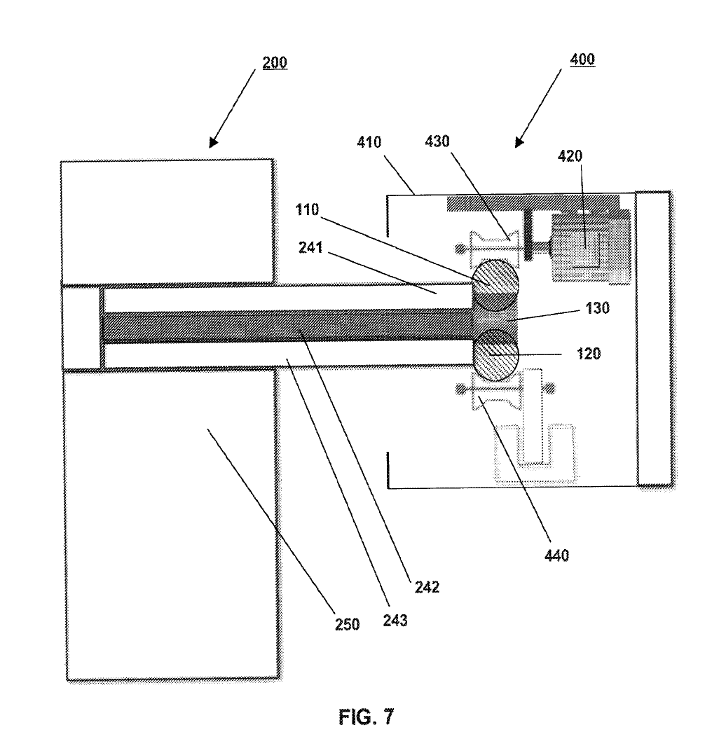

Other methods of fastening the transport line 100 to the line anchor 200 are possible. For example, as shown in FIG. 7, bolts 220 are not required. The transport line 100 may be adhered to the support arm 240. The first cable 110 may be welded to the upper support arm 241 and the second cable 120 may be welded to the lower support arm 243. The middle support arm 242 may be made of any non-conductive material.

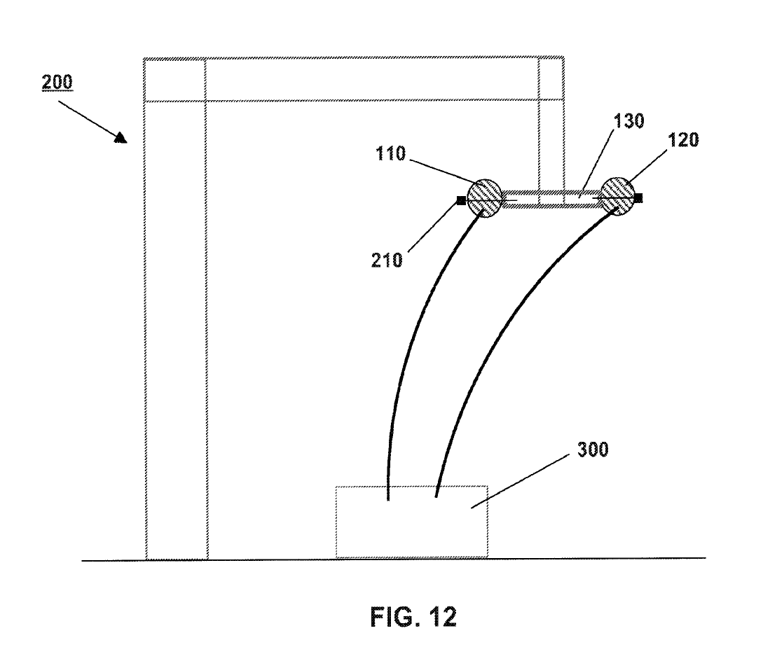

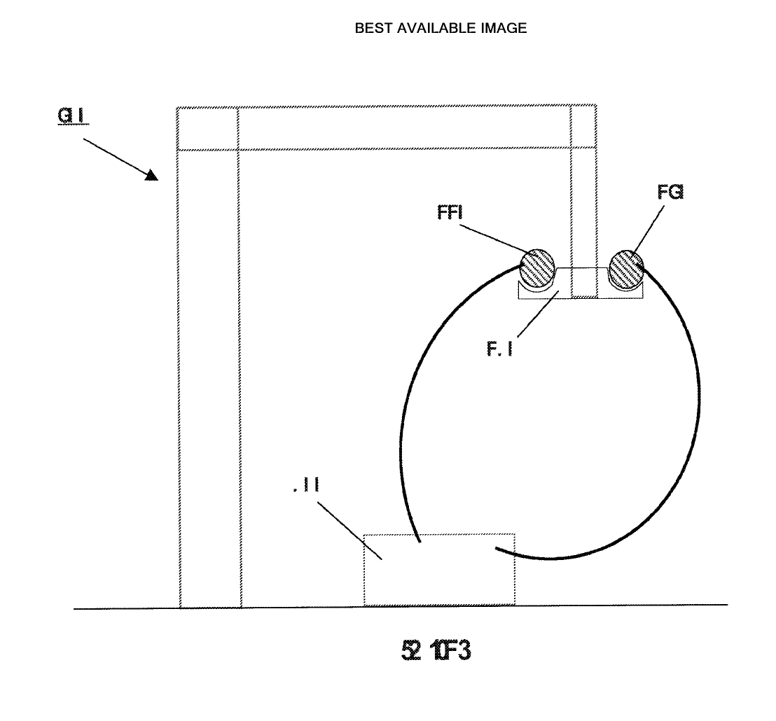

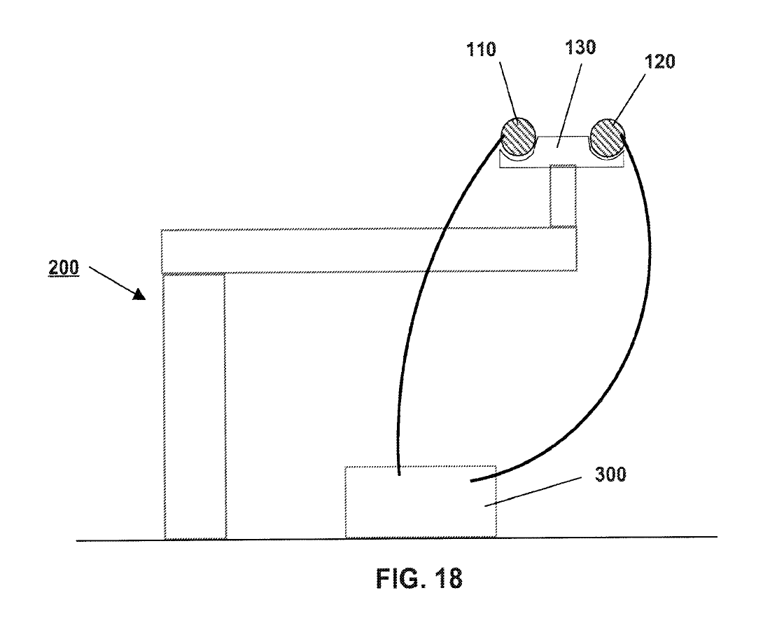

In some embodiments, where line anchor 200 may be a pole 250, as illustrated in FIGS. 4, 7, 12, 15, and 18, the pole may be various configurations to support the chassis 400. For example, the pole 250 in FIGS. 4 and 7 have a support arm 240 that is perpendicular to the vertical pole 250. In FIGS. 12 and 15, the pole 250 is configured to support the chassis 400 from above. In FIG. 18, the pole 250 is configured to support the chassis 400 from below. The pole 250 may be configured to support different embodiments of the transport line 100, for instance, whether the transport line 100 is in a vertical orientation (FIGS. 4 and 7) or in a horizontal orientation (FIGS. 12, 15 and 18).

As shown in FIGS. 1, 12, 15 and 18, the power means 300 is for supplying an electric current to the first cable 110 and the second cable 120. The electric current may be alternating current (AC) or direct current (DC). These figures are illustrative and one of ordinary skill in the art understands that the location and route of the source of the power means 300 to the first cable 110 and second cable 120 may be situated at a location that is convenient for a particular application. For example, although a power means 300 is not depicted in FIG. 4, the power means 300 may be routed along the support arm 240 of line anchor 200 to reach the first cable 110 and the second cable 120. One of ordinary skill in the art understands that the power means 300 may be located and routed in any convenient location as long as location and routing of the power means 300 does not impede the movement of the chassis 400 along the transport line 100.

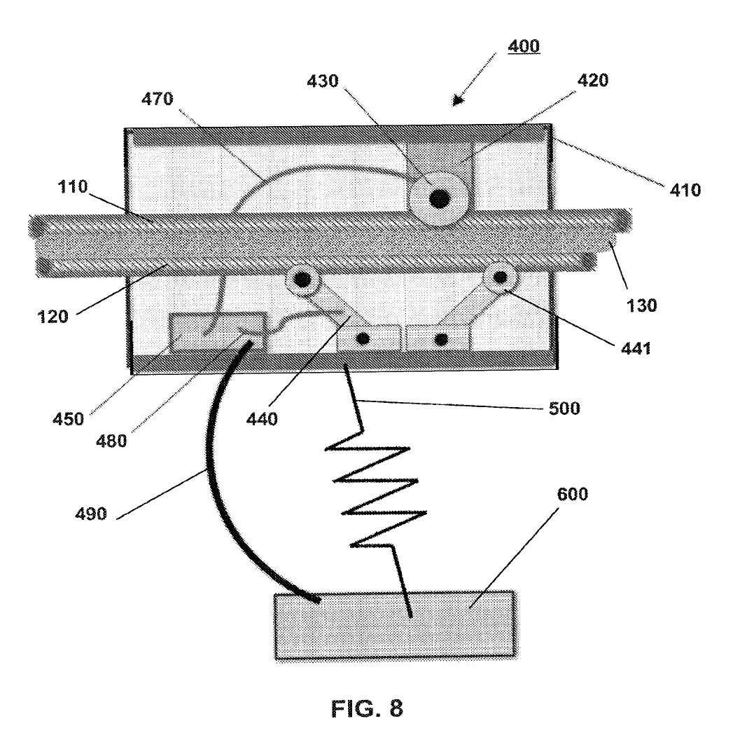

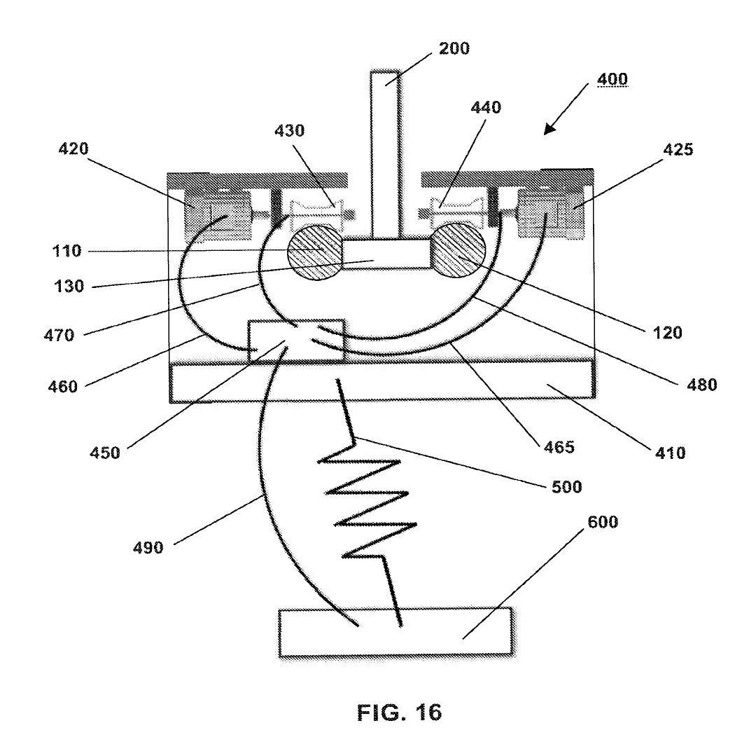

As illustrated in FIGS. 4, 7-9, 16, 17, 19 and 23, the chassis 400 comprises a housing 410, a first motor 420, at least one first cable pulley 430, at least one second cable pulley 440, a junction box 450, a first internal power supply link 460, a first cable pulley-junction box link 470, and a junction box-second cable pulley link 480. The chassis 400 may optionally further comprise a second motor 425, as illustrated in FIGS. 16, 17 and 19. The chassis 400 may also optionally further comprise a second internal power supply link 465, as illustrated in FIGS. 16, 17 and 19. The chassis 400 may also optionally further comprise a plurality of external power supply links 490, as illustrated in FIGS. 8, 9, 16, 17 and 19. The present invention is not limited to one or two motors, as the present invention may be practiced where the chassis 400 may have more than two motors.

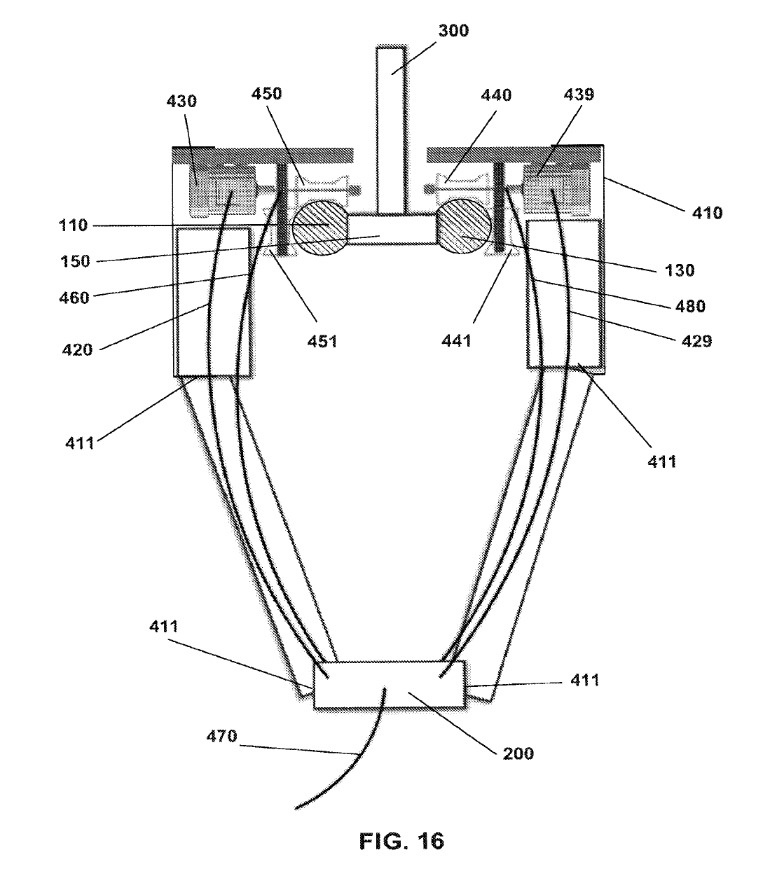

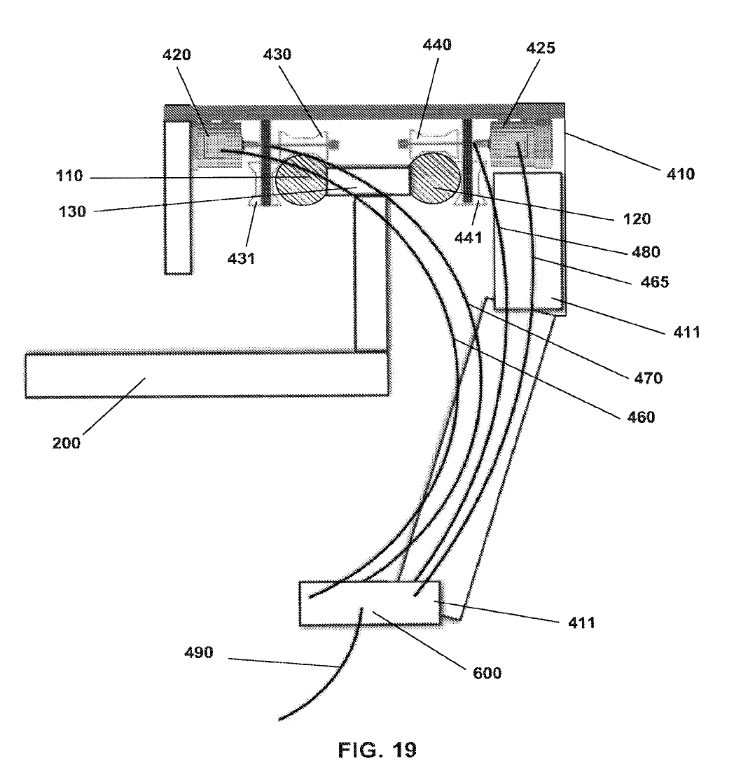

Depending upon the particular application of the motorized transport system 1000, the housing 410 may be designed in various shapes, dimensions and configurations. For example, FIGS. 4, 7-9, 16, 17, 19 and 23 show that the housing 410 has an opening that allows free movement of the chassis 400 along the transport line 100 without being impeded by the line anchors 200. FIGS. 4, 7-9, 16 and 23 depict the housing 410 to be generally of a square or rectangular shape. However, one of ordinary skill of the art understands that the housing 410 is not limited to these shapes. FIGS. 17 and 19 illustrate other possible shapes for the housing 410. Furthermore, FIGS. 17 and 19 illustrate that the housing 410 may have other features, such as pivot joints 411, which allow parts of the chassis 400 to be flexible. When the motorized transport system 1000 is transporting cargo, it may be advantageous for the housing 410 to be able to be flexible. One of ordinary skill in the art understands that the chassis 400 may be adapted to be movable along the transport line 100.

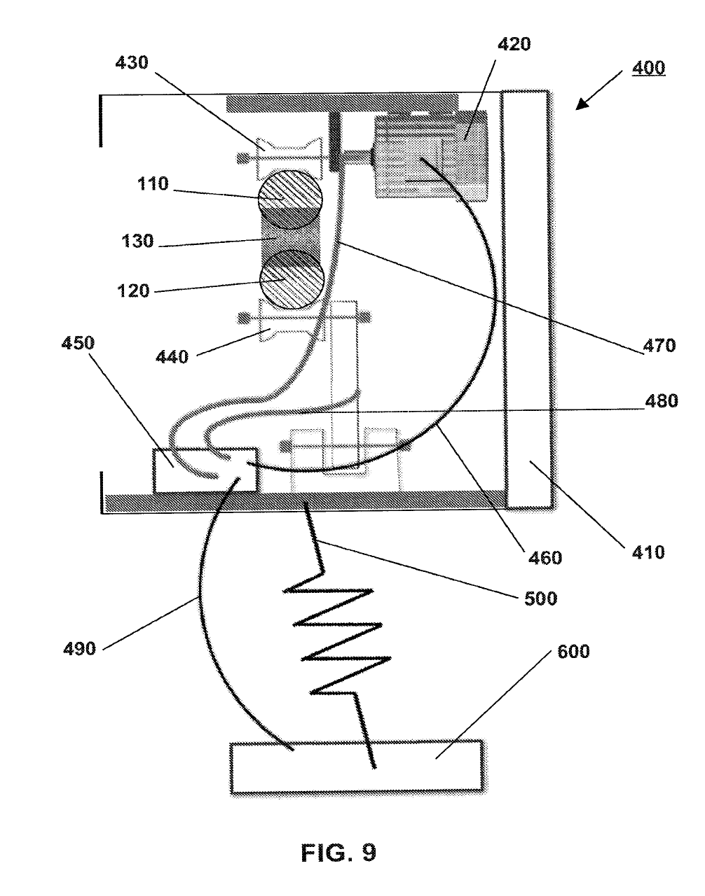

The first cable pulley 430 and the second cable pulley 440 may be designed in various sizes and configurations. For example, referring to FIG. 9, the first cable pulley 430 may be configured to have a wheel and an arm and may be configured to be driven by the first motor 420; while the second cable pulley 440 may be configured to have a wheel, an arm and a base, but may not be configured to be driven by any motor. Whereas the second cable pulley 440 may be configured to be driven by a second motor 425, as shown in FIGS. 17 and 19. The first motor 420 drives the first cable pulley 430 by rotating the wheel of the first cable pulley 430. As the wheel rotates, the chassis 400 moves along the transport line 100. The first motor 420 may drive the first cable pulley 430 by any method known to one of ordinary skill in the art, such as chains, bands, gearboxes, driveshafts, and other known methods.

The motorized transport system 1000 comprises at least one first cable pulley 430 and at least one second cable pulley 440. The present invention may have various combinations of the number of first cable pulleys 430 and second cable pulleys 440. For example, the embodiments illustrated in FIGS. 4, 7, 9 and 16 have one first cable pulley 430 and one second cable pulley 440. Whereas, the embodiments illustrated in FIGS. 17. 19 and 23 have two first cable pulleys 430, 431 and two second cable pulleys 440, 441. Furthermore, the embodiment illustrated in FIG. 8 has one first cable pulley 430 and two second cable pulleys 440, 441. One of ordinary skill in the art understands that the present invention may be practiced with any combination of number of first cable pulleys 430 and second cable pulleys 440. In embodiments with additional first and second cable pulleys 431, 441, such as the embodiments shown in FIGS. 8, 17, 19 and 23, the additional cable pulleys 431, 441 may add stability to the chassis 400 as it moves along the transport line 100. Furthermore, FIG. 8 also illustrates that the wheels of the first cable pulley 430 and second cable pulley 440 may be configured to have different sizes. Having a larger wheel may increase the efficiency of the first motor 420 as the chassis 400 moves along the transport line 100.

As shown in FIGS. 4, 7, 8, 9 and 23, the motorized transport system 1000 comprises at least one second cable pulley 440, 441. The arms supporting the wheels of second cable pulley 440, 441 may include springs (not illustrated in the figures) that exert pressure on the wheels to maintain constant contact with the second cable 120, which in turn exerts pressure on the first cable pulley 430, whereby the first cable 110 maintains constant contact with the first cable pulley 430. This contact keeps the circuit closed, therefore allowing the electrical current to be transferred from the power means 300 to the first cable 110, through the first cable pulley 430, through the first cable pulley-junction box link 470, through the junction box 450, through the junction box-second cable pulley link 480, through the second cable pulley 440, through the second cable 120, and then back to the power means 300. Springs are exemplary and one of ordinary skill in the art understands that other known methods may be utilized to facilitate the exertion of pressure on the wheel to keep the second cable pulley 440 in contact with the second cable 120. For example, in FIG. 8, the two supporting arms may include a spring or an elastic band to pull the two support arms together, thereby making the wheels maintain constant contact with the second cable 120. Furthermore, the springs may be in any location and configuration that facilitates the exertion of pressure on the wheel to keep the second cable pulley 440 in contact with the second cable 120. For example, the spring may be attached at one end to the support arm of the second cable pulley 440, while the other arm is attached to an interior wall of the chassis 400, in a manner that facilitates the exertion of pressure on the wheel to keep the second cable pulley 440 in contact with the second cable 120 and does not impede the motion of the chassis 400 along transport line 100.

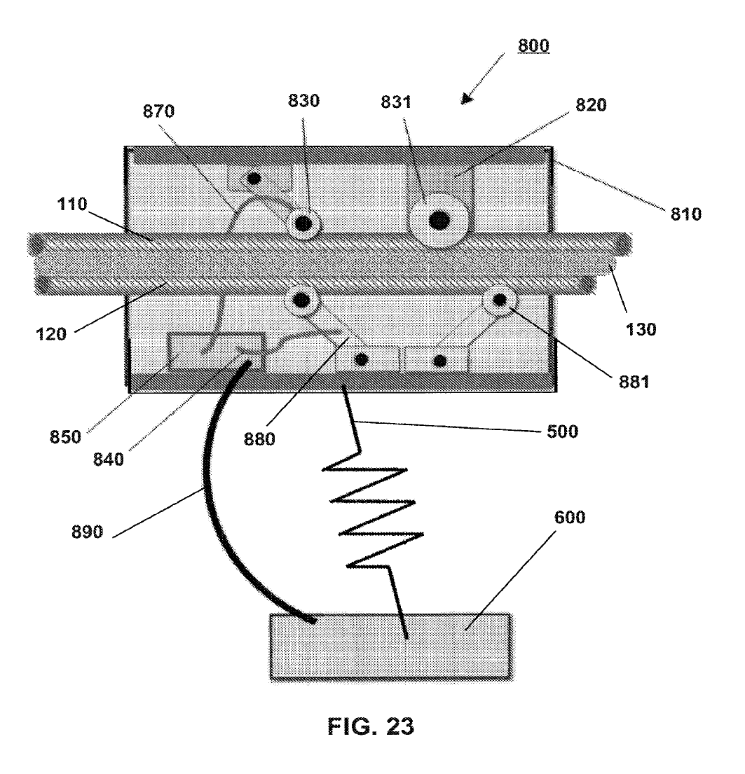

Preferably, the first cable pulley 430, 431 and the second cable pulley 440, 441 each have conductive and insulating sections. For example, referring to FIG. 8, the second cable pulley 440, 441 may be made of three sections: the wheel, the support arm and the base that attaches to the chassis 400. The wheel may have an outer ring that contacts the second cable 120 and the support arm; the wheel also has an inner ring. The support arm and the outer ring are conductive, whereas the inner ring and base are insulating. This configuration allows the completion of the closed circuit. Additionally, it is preferable that the first cable pulley 430 is made in the same or similar manner. In doing so, when there is a first motor 420 that drives the first cable pulley 430 to facilitate movement of the chassis 400 along transport line 100, the first motor 420 will not have any affect on the closed circuit because the first motor 420 will be insulated from the closed circuit because the first motor 420 will only be in contact with the inner ring, which is an insulator. As illustrated in FIG. 8, the first motor 420 may be associated with a cable pulley that is part of the closed circuit, such as the first cable pulley 430. However, the present invention is not limited to such a configuration. As illustrated in FIG. 23, the first motor 420 may be associated with a cable pulley that is not part of the closed circuit, such as the first cable pulley 431. The first internal power supply link 460 has been omitted from certain figures, such as FIGS. 8 and 23 for clarity purposes.

As shown in FIGS. 8, 9, 16, 17, 19 and 23, the first cable pulley-junction box link 470 connects the first cable pulley 430 to the junction box 450. The junction box-second cable pulley link 480 connects the junction box 450 to the second cable pulley 440. The power means 300, the first cable 110, the first cable pulley 430, the first cable pulley-junction box link 470, the junction box 450, the junction box-second cable pulley link 480, the second cable pulley 440, and the second cable 120 form a closed circuit. Preferably, the first cable pulley-junction box link 470 and the junction box-second cable pulley link 480 are insulated conductors, such as electrical wires, that carry a single polarity current. Preferably, the first cable pulley-junction box link 470 and the junction box-second cable pulley link 480 are single-wire transmission lines that transmit electric power using only a single electrical conductor.

As illustrated in FIG. 9, the first internal power supply link 460 provides electrical power from the junction box 450 to the first motor 420, which drives the first cable pulley 430. The chassis 400 may utilize an optional second internal power supply link 465 to provide electrical power to an optional second motor 425, which drives the second cable pulley 440, as shown in FIGS. 16, 17 and 19. One of ordinary skill of the art understands that the present invention may utilize additional internal power supply links to provide electrical power to additional motors or other electrical components that may be utilized by the present invention. Preferably, the first internal power supply link 460 and the second internal power supply link 465 are insulated conductors, such as electrical wires, that carry dual polarity current. Preferably, the first internal power supply link 460 and the second internal power supply link 465 are cables having two or more wires running side by side and bonded, twisted, or braided together to form a single assembly.

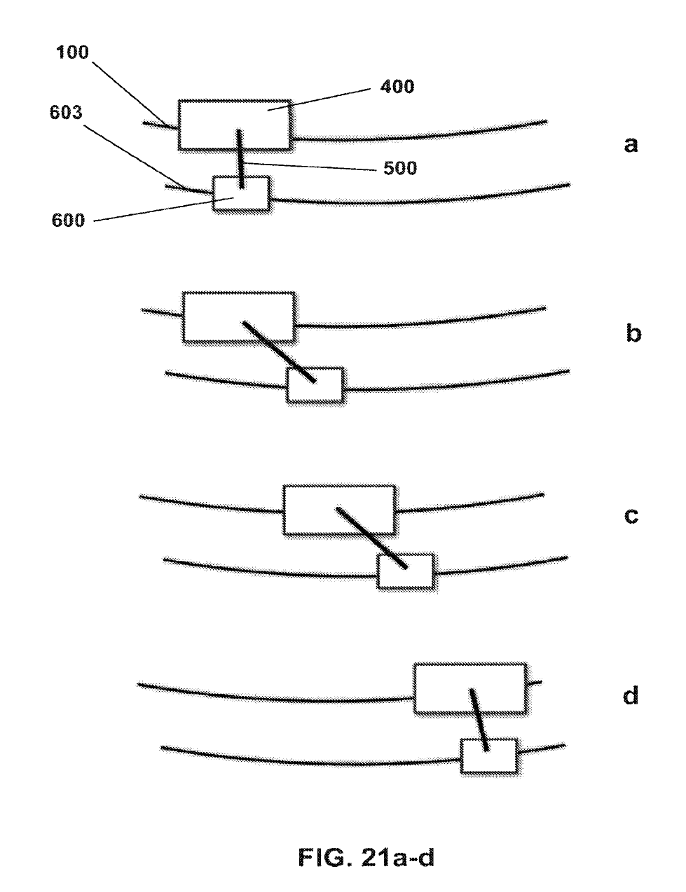

As shown in FIGS. 8, 9, 16, 17, 19, 20, 21 (a-d) and 23, the motorized transport system 1000 may optionally further comprise a load connector 500. The load connector 500 extends from the chassis 400. The motorized transport system 1000 may optionally further comprise a load container 600. The load connector 500 may couple the load container 600 to the chassis 400. Preferably, the load connector 500 is flexible thereby allowing and facilitating the independent movements of the chassis 400 and the load container 600. In other words, the chassis 400 may be in motion while the load container 600 is not in motion. FIG. 21 illustrates this independent movement. In FIG. 21a-d, load container has a motor to move along the support line 603. The support line 603 may not be electrified; in this example, the chassis 400 supplies power to the motor in the load container 600 via an external power supply line 490 (not included in FIG. 21a-d for clarity purposes). In FIG. 21a, neither the chassis 400 nor the load container 600 are in motion. Then, in FIG. 21b, the chassis 400 supplies power to the motor in the load container 600. The motor then drives the load container 600 along the support line 603. The load container 600 is in motion while the chassis 400 is not in motion. The flexibility of the load connector 500 allows this to occur. Eventually, the load connector 500 is stretched and the load container 600 begins pulling the chassis 400 along the transport line 100, as shown in FIG. 21c. Both the load container 600 and the chassis 400 are in motion until the load container 600 stops, as shown in FIG. 21d. The chassis 400 will stop its motion shortly thereafter.

Alternatively, when load container 600 starts moving, it may transmit a signal to the chassis 400. After receiving the signal, the motors within the chassis 400 begin to operate and both the load container and chassis 400 move in the same direction together at the same speed. As a result, the load container 600 is not pulling the chassis 400. When the load container 600 stops, it sends another signal to the chassis 400 for the chassis 400 to stop. The signal may be transmitted via wire or wirelessly. The load container 600 and the chassis 400 may utilize software and sensors for communication of motions.

The load connector 500 may be, for example, a hook. The hook may be used to connect to cargo that is held by a cargo net or a box with an “eye” to connect to the hook. The load container may be a tram, gondola, carriage, shipping container, or any other cargo carrier known to one skilled in the art. Cargo may be any transportable article, including humans and livestock.

As illustrated in FIGS. 8, 9, 16, 17, 19 and 23, the chassis 400 may further comprise an external power supply link 490, which provides electrical power from the junction box 450 to the load container 600.

The load container 600 may optionally comprise an HVAC system, which receives electrical power from the external power supply link 490. HVAC means heating, ventilation and air conditioning, which may be utilized to control the climate within the load container 600, when transporting, for example people, livestock, food, medicine, or any other perishable items.

The load container 600 may optionally comprise an illumination system, which receives electrical power from the external power supply link 490. The load container 600 may optionally comprise a wireless fidelity system, which receives electrical power from the external power supply link 490. The load container 600 may optionally comprise a load container motor, which receives electrical power from the external power supply link 490.

The motorized transport system 1000 may optionally comprise a motor controller system. The motor controller system is preferably located within the load container 600. The motor controller system receives electrical power from the external power supply link 490. The motor controller system operates the first motor 420 and the second motor 425. One of ordinary skill in the art understands that the motor control system is not limited to be located within the load container 600. The motor controller system may be located in a remote location and the motor controller system may utilize wireless technology to operate the first motor 420 and the second motor 425. Furthermore, the motorized transport system 1000 may include other controller system, for example, a system to control the HVAC and illumination systems.

The junction box 450 may optionally comprise a transformer, an inverter, and a rectifier. As noted previously, the power means 300 may supply AC or DC. If the power means 300 supplies AC, then the rectifier will convert AC to DC, as some electrical components only utilize DC. On the other hand, if the power means 300 supplies DC, then the inverter will convert DC to AC, as some electrical components only utilize AC. The transformer may be utilized to transfer electrical energy between two or more circuits. The transformer may also be utilized to increase or decrease the alternating voltages in electrical power applications. The present invention is not limited to the electrical systems specifically referenced here and in the figures, as one of ordinary skill in the art understands that the present invention may utilize other components that require electrical power, such as computers, computer chips, memory, sensors, braking systems and other components of transport systems.

Another embodiment of the present invention is a motorized transport system 1000 comprising: a transport line 100; a plurality of line anchors 200; a power means 300; a chassis 400; a load connector 500; and, a load container 600. The transport line 100 comprises: a first cable 110; a second cable 120; and, an insulation layer 130. The first cable 110 is made of a first conductor and the second cable 120 is made of a second conductor. The insulation layer 130 is made of an insulator; bonds the first cable 110 to the second cable 120; insulates the first cable 110 from the second cable 120; and, does not allow the first cable 110 to contact the second cable 120. The transport line 100 is fastened to the plurality of line anchors 200. The power means 300 supplies an electric current to the first cable 110 and the second cable 120. The chassis 400 comprises: a housing 410; plurality of external power supply links 490; at least one first cable pulley 430; at least one second cable pulley 440; a junction box 450; a first cable pulley-junction box link 470; and, a junction box-second cable pulley link 480. The load connector 500 extends from the chassis 400. The load connector 500 couples the load container 600 to the chassis 400. The plurality of external power supply links 490 provides electrical power from the junction box 450 to the load container 600. The chassis 400 is adapted to be movable along the transport line 100. The first cable pulley-junction box link 470 connects the at least one first cable pulley 430 to the junction box 450. The junction box-second cable pulley link 480 connects the junction box 450 to the at least one second cable pulley 440. The power means 300, the first cable 410, the at least one first cable pulley 430, the first cable pulley-junction box link 470, the junction box 450, the junction box-second cable pulley link 480, the at least one second cable pulley 440, and the second cable 120 form a closed circuit. The chassis 400 may optionally comprise: a first motor 420 and a first internal power supply link 460. The first internal power supply link 460 provides electrical power from the junction box 450 to the first motor 420. The first motor 420 drives the at least one first cable pulley 430.

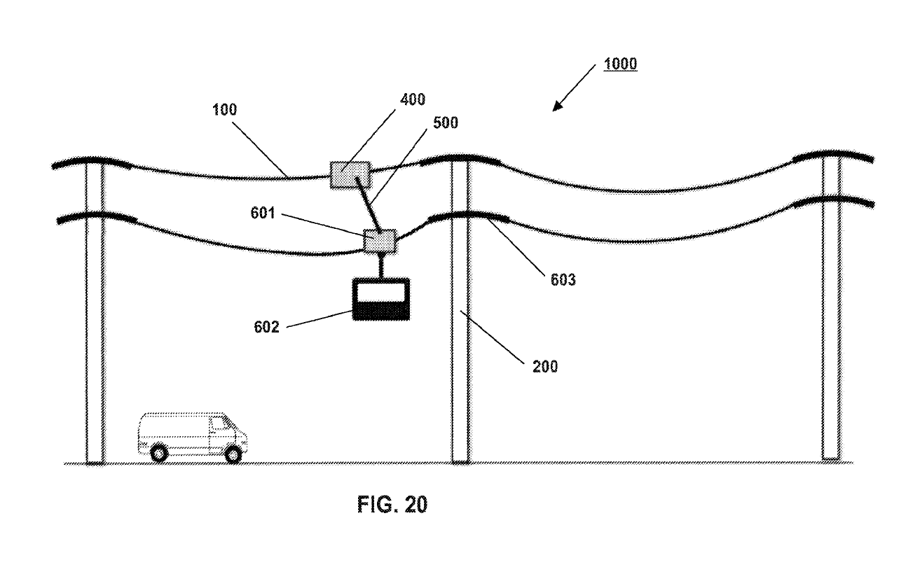

FIG. 20 illustrates an embodiment of the motorized transport system 1000. The chassis 400 moves along the transport line 100. The transport line 100 is fastened to a plurality of line anchors 200. The load container 600 is illustrated in this figure to have a top section 601 and a bottom section 602. The chassis 400 is connected to the top section 601 of the load container 600 by a load connector 500. The top section 601 may optionally have a motor. The chassis supplies power to the motor in the top section 601. The chassis 400 has motors as well. The motor in the top section 601 aids movement of the motorized transport system 1000. The motor in the top section 601 moves along the support line 603, which is not electrified in this example. One of ordinary skill in the art understands the many advantages of the load connector 500 being flexible. For example, the flexibility allows the chassis 400 and the load container 600 to not be forced to start or stop at the exact same moment. Similarly, the pivot joints 411, for embodiments of the chassis 400 illustrated in FIGS. 17 and 19, may serve the same purpose. One of ordinary skill in art understands that FIG. 20 is illustrative and non-limiting, as many configurations are possible utilizing the present invention. For example, additional chassis 400 may be added to transport line 100. Furthermore, although FIG. 20 illustrates the utilization of one chassis 400 and one load container 600, the present invention may be practiced with as many chassis 400 and load containers 600 as required for a given application.

FIG. 22 illustrates three motorized transport systems 1000 working together. Illustrated are a first chassis 401 that moves along a first transport line 101, a second chassis 402 that moves along a second transport line 102, and a third chassis 403 that moves along a third transport line 103. One end of the first transport line 101 is connected to the first line anchor 201, while the other end of the first transport line 101 is connected to the second line anchor 202. Similarly, one end of the second transport line 102 is connected to the first line anchor 201, while the other end of the second transport line 102 is connected to the second line anchor 202. One end of the third transport line 103 is connected to the first chassis 401, while the other end of the third transport line 101 is connected to the second chassis 402. The first chassis 401 and the second chassis 402 serve as line anchors 200 in this example. The first chassis 401 and second chassis 402 move in the same direction. In this embodiment, cargo attached to the third chassis 403 may be transported to anywhere in the area defined by the first line anchor 201, the second line anchor 202, the first transport line 101 and the second transport line 102. One of ordinary skill in art understands that FIG. 22 is illustrative and non-limiting, as many configurations are possible utilizing the present invention. For example, additional chassis 400 may be added to first transport line 101, second transport line 102 and third transport line 103. Furthermore, although FIG. 22 illustrates the utilization of three motorized transport systems 1000, the present invention may be practiced with as many motorized transport systems 1000 as required for a given application.

Additionally, although not depicted in figures, nor described in detail above, the present invention may utilize components that are known to one of ordinary skill in the art. For example, the present invention may utilize brake systems that slow and stop the movement of the chassis 400 and the load container 600. Furthermore, the circuit may include an electrical switch that may be used to interrupt the current flow in a circuit. Additionally, one of ordinary skill in the art understands that the present invention may utilize insulating elements that are not specifically described. These insulating elements are necessary to minimize the number of pathways to create an electrical circuit.

I claim:

1. A motorized transport system comprising:
a transport line, wherein the transport line comprises:
a first cable, wherein the first cable is made of a first conductor;
a second cable, wherein the second cable is made of a second conductor; and,
an insulation layer, wherein the insulation layer is made of an insulator; wherein the insulation layer bonds the first cable to the second cable; wherein the insulation layer insulates the first cable from the second cable; and, wherein the insulation layer does not allow the first cable to contact the second cable;
a plurality of line anchors, wherein the transport line is fastened to the plurality of line anchors;
a power means for supplying an electric current to the first cable and the second cable; and,
a chassis, wherein the chassis comprises:
a housing;
a first motor;
at least one first cable pulley;
at least one second cable pulley;
a junction box;
a first internal power supply link;
a first cable pulley-junction box link; and,
a junction box-second cable pulley link;
wherein the chassis being adapted to be movable along the transport line;
wherein the first cable pulley-junction box link connects the at least one first cable pulley to the junction box;
wherein the junction box-second cable pulley link connects the junction box to the at least one second cable pulley;
wherein the power means, the first cable, the at least one first cable pulley, the first cable pulley-junction box link, the junction box, the junction box-second cable pulley link, the at least one second cable pulley, and the second cable form a closed circuit;
wherein the first internal power supply link provides electrical power from the junction box to the first motor; and,
wherein the first motor drives the at least one first cable pulley.

2. The motorized transport system of claim 1, wherein the insulator is selected from a group consisting of epoxy, glass, rubber, fiberglass, porcelain, ceramic, quartz, plastic, diamond and combinations thereof.

3. The motorized transport system of claim 2, wherein the insulator is epoxy.

4. The motorized transport system of claim 3, wherein the first conductor is selected from a group consisting of silver, copper, gold, aluminum, zinc, nickel, tin, brass, bronze, steel, iron, platinum, lead, and combinations thereof; and, wherein the second conductor is selected from a group consisting of silver, copper, gold, aluminum, zinc, nickel, tin, brass, bronze, steel, iron, platinum, lead, and combinations thereof.

5. The motorized transport system of claim 4, wherein the first conductor is copper; and, wherein the second conductor is copper.

6. The motorized transport system of claim 5, wherein the chassis further comprises:
a second motor; and,
a second internal power supply link, wherein the second motor drives the at least one second cable pulley.

7. The motorized transport system of claim 6, wherein the motorized transport system further comprises:
a load connector, wherein the load connector extends from the chassis.

8. The motorized transport system of claim 7, wherein the motorized transport system further comprises:
a load container, wherein the load connector couples the load container to the chassis.

9. The motorized transport system of claim 8, wherein the chassis further comprises a plurality of external power supply links; and, wherein the plurality of external power supply links provides electrical power from the junction box to the load container.

10. The motorized transport system of claim 9, wherein the load container comprises:
an HVAC system, wherein the HVAC system receives electrical power from the plurality of external power supply links.

11. The motorized transport system of claim 10, wherein the load container comprises:
an illumination system, wherein the illumination system receives electrical power from the plurality of external power supply links.

12. The motorized transport system of claim 11, wherein the load container comprises:
a wireless fidelity system, wherein the wireless fidelity system receives electrical power from the plurality of external power supply links.

13. The motorized transport system of claim 12, wherein the motorized transport system further comprises: a motor controller system.

14. The motorized transport system of claim 13, wherein the motor controller system is located within the load container; and, the motor controller system receives electrical power from the plurality of external power supply links; and, wherein the motor controller system operates the first motor and the second motor.

15. The motorized transport system of claim 14, wherein the junction box comprises:
a transformer;
an inverter; and,
a rectifier.

16. The motorized transport system of claim 15, wherein the load container comprises: a load container motor, wherein the load container motor receives electrical power from the plurality of external power supply links.

17. A motorized transport system comprising:
a transport line, wherein the transport line comprises:
a first cable, wherein the first cable is made of a first conductor;
a second cable, wherein the second cable is made of a second conductor; and,
an insulation layer, wherein the insulation layer is made of an insulator; wherein the insulation layer bonds the first cable to the second cable; wherein the insulation layer insulates the first cable from the second cable; and, wherein the insulation layer does not allow the first cable to contact the second cable;
a plurality of line anchors, wherein the transport line is fastened to the plurality of line anchors;
a power means for supplying an electric current to the first cable and the second cable;
a chassis, wherein the chassis comprises:
a housing;
plurality of external power supply links;
at least one first cable pulley;
at least one second cable pulley;
a junction box;
a first cable pulley-junction box link; and,
a junction box-second cable pulley link;
a load connector, wherein the load connector extends from the chassis; and,
a load container, wherein the load connector couples the load container to the chassis;
wherein the plurality of external power supply links provides electrical power from the junction box to the load container;
wherein the chassis being adapted to be movable along the transport line;
wherein the first cable pulley-junction box link connects the at least one first cable pulley to the junction box;
wherein the junction box-second cable pulley link connects the junction box to the at least one second cable pulley; and,
wherein the power means, the first cable, the at least one first cable pulley, the first cable pulley-junction box link, the junction box, the junction box-second cable pulley link, the at least one second cable pulley, and the second cable form a closed circuit;

18. The motorized transport system of claim 17, wherein the chassis further comprises:
a first motor; and,
a first internal power supply link;
wherein the first internal power supply link provides electrical power from the junction box to the first motor; and,
wherein the first motor drives the at least one first cable pulley.
